(19) United States
(12) Patent Application Publication
(10) Pub. No.: US 2005/0257425 A1
(43) Pub. Date: Nov. 24, 2005

(54) Bulb planting method

(76) Inventor: Jack Van de Wetering, Baiting-Hollow, NY (US)

Correspondence Address: Thomas A. O'Rourke;Bodner & O'Rourke, L.L.P., Ste. 108, 425 Broadhollow Road, Melville, NY, 11747, US

(21) Appl. No.: 11/123,245

(22) Filed: May 5, 2005

Related U.S. Application Data
(60) Provisional application No. 60/568,202, filed on May 5, 2004.

(51) Int. Cl. A01G 9/02

(52) U.S. Cl. 47/73

(57) ABSTRACT

A planter for planting bulbs and the like is described. The planter is in the form of a container with an open end for receiving one or more plants and a soil mixture. The container has a plurality of openings in its bottom for roots to pass through. The orifices in the planter for the roots have an edge that cuts the roots when the planter is twisted or turned.

This is a conversion of U.S. Provisional Patent Application Ser. No. 60/568,202 filed May 5, 2004, the disclosures of which are incorporated herein by reference.

One very common hobby that many people enjoy is gardening. Unfortunately, people today do not have as much leisure time as they have in the past. Work and family commitments have reduced the ability of many people to have hobbies that they once enjoyed.

Gardening has many benefits. The work in the garden provides exercise and a means to get one's mind off of the day to day activities. In the past, many gardeners had certain natural time tables or rhythms that they followed in attending to their gardens. In January the catalogs would come in and plans were made for the coming season. In the late winter warm weather vegetables and other tender plants would be started from seed indoors. As the soil warmed, the cold season vegetables would be planted directly in the garden. The succession of planting chores would continue into the late summer and fall when many gardeners would plant spring bulbs for the following year before the ground froze.

As people have had more and more other activities to contend with, particularly in the fall as the warm weather ends, it has been apparent that many gardeners have not had the time or have failed to plan ahead and plant their spring flowering bulbs in a timely manner before the ground freezes. Also, the vagaries of the fall weather are such that a gardener can experience a sudden cold snap after a period of warm weather that causes the gardener to postpone the chores until next week and then it never gets warm again to plant. Many gardeners start off the fall with good intentions but as the warm days of fall end they find that their other activities have prevented them from planting the bulbs and now the ground is too hard or sometimes covered with snow. Also, as the population has aged many of the older gardeners have difficulty in digging the holes necessary for planting especially the deep holes needed for bulbs. This has become particularly apparent at many garden centers where there has been a decrease in fall bulb sales. Unfortunately, many of the customers express regret at not having planted the bulbs when later in the spring their neighbors have beds of tulips and daffodils and their homes do not have the traditional spring blooms that so many people enjoy.

One of the reasons why the spring bulbs must be planted in the late summer and early fall is that the bulbs need time to set out their roots before the severe frosts freeze the ground. The bulbs lie dormant in their beds until they begin to grow upward in the spring. One of the issues with the bulbs is that they need to be planted deep enough so that they do not suffer from the cold weather of winter. As a result bulbs typically need to be planted about 3-8 inches deep depending on the variety. One of the interesting features of many of the bulbs is that while they dislike truly frigid temperatures, they do need a period of cold weather in the winter. Typically, bulbs must be kept below about 45 degrees Fahrenheit for some period of time in order to properly bloom in the spring. Thus, bulbs purchased in the fall do not readily bloom if kept in their packaging and planted in the spring. It is also not uncommon for a home owner who has purchased bulbs in the fall but been unable to properly plant them to try to grow the bulbs in the spring. The average gardener is typically unable to properly care for the bulbs over the winter. Very few gardeners are equipped to storing the bulbs in sand or soil at the requisite temperatures so that the bulbs will grow in the spring. Gardeners who try to keep the bulbs in a refrigerator will frequently find that there is too much humidity in the refrigerator and the bulbs may suffer from rot.

The gardener who wishes to have a bulb garden in early spring who was unable to dig his beds in the fall and plant the spring bulbs have very limited choices. While many garden centers offer potted bulbs in the spring time, these plants are frequently been forced in a hot house and are not adapted to the cold damp ground of early spring. Thus, these potted spring bulbs are primarily indoor plants and not really for outdoor use.

One of the other problems encountered by gardeners who have spring flowering bulb gardens in the unsightly foliage left after the plants bloom. Gardeners who hope for the bulbs to grow again the following spring must not cut the dying foliage until it significantly dies off, and the nutrients in the bulbs have been replenished for the next year.

Another problem with many spring flowering bulbs, particularly tulips, are garden pests. These bulbs are popular among many members of the local fauna such as voles, squirrels and deer. Each of these mammals has fondness for one or more varieties of spring flowering bulbs and can make quick work of a bed of spring bulbs.

Thus there is a need for an easier way of planting spring flowering bulbs that avoids the problems of the prior bulbs.

### OBJECTS OF THE INVENTION

It is an object of the invention to provide a means for planting a pre-designed garden in a simple, easy manner.

It is an object of the invention to provide an improved planting method for planting spring flowering bulbs, summer flowering bulbs, perennials and flowering annuals.

It is an object of the invention to provide an improved planter for planting spring flowering bulbs, summer flowering bulbs, perennials and flowering annuals.

It is a further object of the invention to provide a means of planting spring bulbs without having to dig into the ground.

It is a another object of the invention to provide a planting means for removing bulbs from a bed so that the plants can store food for the coming winter without the gardener having to look at the dying yellow leaves of the bulbs.

It is still a further object of the invention to provide a means for growing bulbs outdoors and if gardener desires to bring bulbs into the home while flowering, they enjoy as an indoor blooming plant.

It is a still further object of the invention to provide a planter for planting bulbs that will protect the bulbs from voles and other burrowing animals.

It is another object of the invention to provide a means that facilitates removal from garden and storage of non-hardy summer flowering bulbs.

It is still another object of the invention to provide a planter that will reduce the loss of bulbs to squirrels and deer.

It is a still further object of the invention to provide an improved planter which may readily cut roots extending from the planter so that the plants may be moved to a new location.

### SUMMARY OF THE INVENTION

The present invention is directed to an improved method and apparatus for planting a variety of plants but has particular application to spring flowering bulbs. The present invention also has applicability to removing the bulbs in the late spring. The apparatus has a base which may be generally flat, and one or more sidewalls extending upwardly from the base. The sidewalls typically are about 2-3 inches, however higher sidewalls are possible. The base is provided with a plurality of orifices so that water and roots from the bulbs may pass through the base as the plants grow. In one embodiment at least one of the side walls are also provided with a plurality of orifices extending through at least one of the sidewalls. In another embodiment, there are no orifices in the sidewall.

One or more bulbs may be placed in the planting device depending on whether the gardener desires a series of single plants or a mass of plants in the landscape. A suitable soil mixture also is placed in the device. The soil mixture can be any one of the commercially available mixtures or a specially designed mixture as the gardener desires.

Many spring and summer bulbs are composed of a compressed stem, and fleshy, modified leaves surrounding a bud or growing point. The compressed stem forms the basal plate and is the part from which roots and the growing point develop. The fleshy, modified leaves are responsible for food storage and protecting the bud. The outermost layer is a dry, papery, reddish-brown coat known as the tunic. Overall, this structure enables the plant to survive in a dry, dormant state for many months.

The ideal time for planting many spring flowering bulbs is from late September into early November, but many people report success planting as late as mid December, though it is not recommended. Moisture triggers the dormant bulb to begin growth, and as soon as the bulb is in the moist soil it begins to awake. By December a bulb planted in October will have developed a dense root system, and a healthy shoot that is found not far below the soil surface. Little more happens in the growth cycle until the soil begins to thaw in late winter and early spring at which time the shoot begins to grow again and emerges from the soil. By early or mid-April the typical bulbs opening. The flowering season usually extends through mid to late May.

The leaves are also developing during the flowering period. The foliage of the bulbs plays an essential role in the life cycle. The leaves are responsible for converting the energy of sunlight into food through the process known as photosynthesis. The food, in the form of carbohydrates, is necessary for growth and flowering the following year and is stored in the bulb. So as unsightly as the large, floppy leaves are, they should not be cut down. Rather, the leaves should be left to turn yellow and whither at which point they can be removed. Once the leaves are gone, the bulb enters a dormancy, completing the yearly growth cycle. Bulbous plants will not flower again unless their leaves, which manufacture starch and sugars through photosynthesis, have time to replenish the depleted food supply of the bulb for the coming year. To replenish they create embryos for the next year's flowers and, in the case of corms, produce new corms to replace the old ones. This process continues for weeks after the flowers die. And even after the foliage has completely withered, the bulbs are at work below ground. Whether they are lifted and stored for winter in warm climates or left to winter in the cold, they continue to undergo chemical change to prepare for the next cycle.

Tulips are among the most popular of the bulbous plants. However, there are several other beautiful flowering plants from true bulbs, corms, tubers, or rhizomes that provide color in the landscape. These include spring- and summer-flowering bulbs (daffodils, lilies, and hyacinths), and tubers (anemones), corms (gladiolus, crocus, and freesia), tuberous roots (ranunculus and dahlia), and rhizomes (cannas and callas).

Unlike the prior art bulb planting methods where the bulbs must be dug into the ground, the planting device of the present invention can be placed on top of the ground in a suitable location in the garden and the gardener is not required to dig a hole in the ground and set the bulbs in the ground. The present invention gives the gardener a simple easy means of planting a bulb garden without having to dig into the ground. This is particularly beneficial where the ground is hard to dig or rocky or the gardener no longer has the strength or desire to dig a bed for the bulbs. The present invention is also suitable where the ground's soil is unduly moist or sandy since the apparatus sits on the top surface and is separated from the soil below in its own ecosystem with proper soil and nutrients. Once placed on the ground in the garden, the gardener can place a substrate such as soil, mulch or a potting mixture around the sides of the device to smooth the transition from the top of the pot to the top surface of the adjacent ground.

The planters of the present invention can be planted at any suitable time. As the bulbs grow, the roots will fill the container and if necessary can pass through the orifices in the base and the sidewalls. The base of the present invention has a plurality of orifices to facilitate root growth and drainage.

When the bulbs have finished blooming in the spring the gardener can twist the apparatus by holding, for example, the sidewalls thus using the sidewalls of the orifices in the base to sever the roots passing through the orifices. The edges of the orifices can be provided with an angle to provide a cutting edge for severing the roots passing through the orifices. Thus, the bulbs and the container can be moved to another location where the foliage can replenish the bulbs without the foliage being unsightly in the bed. In addition, the bed is freed up for the planting of other annuals or perennials as desired so that the gardener has a series of blooms over the gardening season.

In one embodiment a biodegradable or other covering can be placed over the top edge or generally the area of the interior of the sidewall to prevent or at least reduce the risk of ingress of deer and squirrels and other vermin. This covering is preferably water permeable and would permit the roots generated by the bulbs to pierce the covering in the spring and pass through or push it up. In one embodiment the covering can be a mesh which would prevent animals from getting at the bulbs but permitting the bulbs foliage to pass through, or the mesh may be pushed up with foliage and out of the way of the bulbs.

### BRIEF DESCRIPTION OF THE DRAWINGS

FIG. 1 is a side view of one embodiment of the device of the present invention in rectangular form.

FIG. 2 is a top view of the device of the present invention where the device is in the form of a circle.

FIG. 3 is a bottom view of the device of FIG. 2.

FIG. 4 is a side view of the device of FIG. 1 placed on the ground with a portion of dirt placed on either side.

FIG. 5 is a top view of the device of the present invention with the mesh cover in place.

FIG. 6 is a top view of the device with a broader top edge and the mesh cover in place.

FIG. 7 is a side view of an orifice.

FIG. 8 is a bottom view of a preferred embodiment of the planter of the present invention.

FIG. 9 is a cut out portion of the strips of FIG. 8.

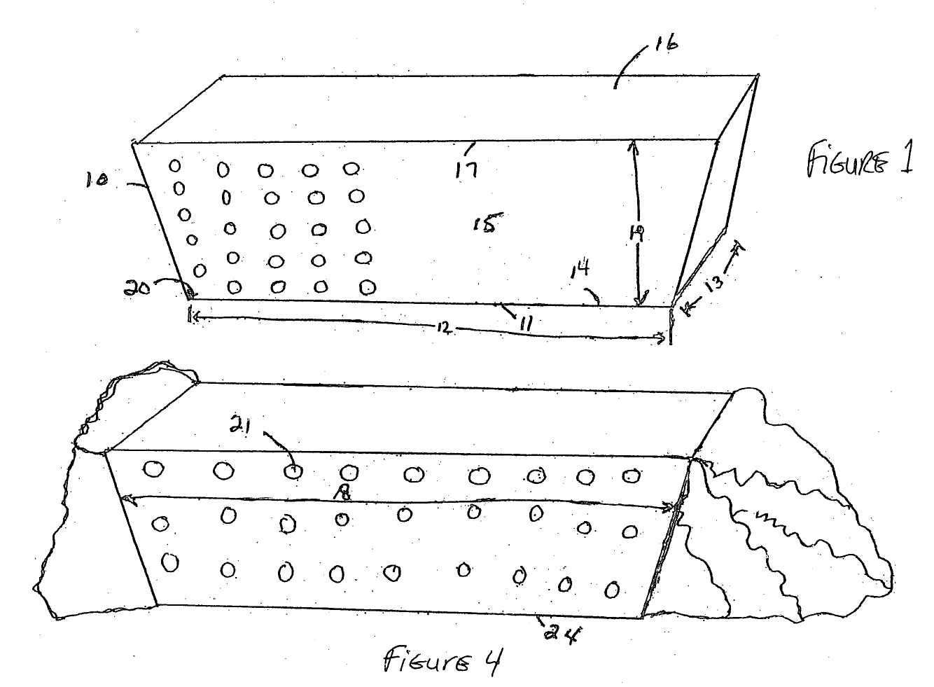

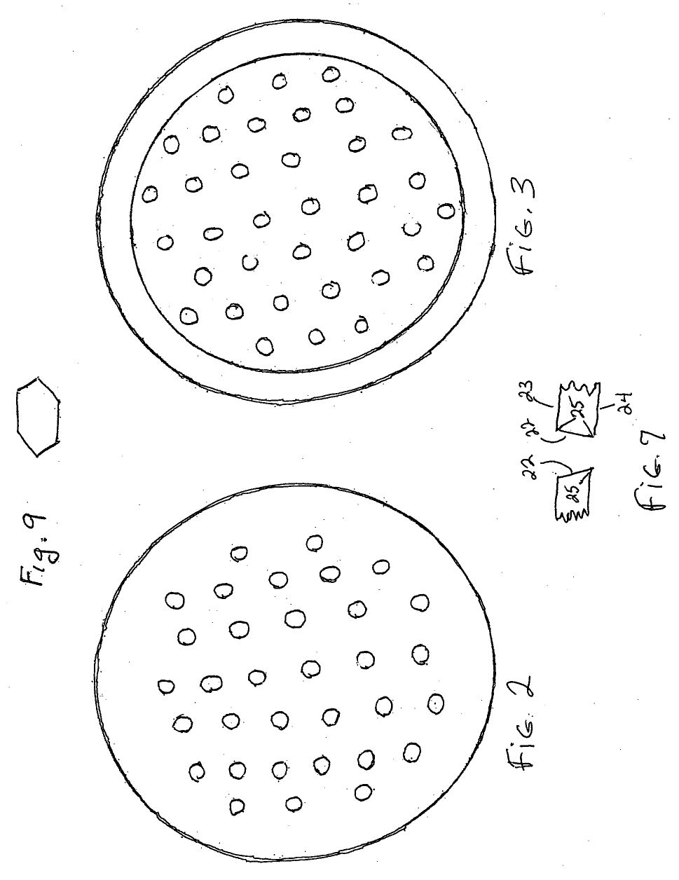

### DETAILED DESCRIPTION OF THE INVENTION

The planting apparatus 10 of the present invention has a base 11 with a length 12 and a width 13. The base 11 is generally horizontal. The base may be any desired shape. Although the device of the present invention is shown with a generally rectangular shape, the base and thus the planter can be any suitable shape such as round, square, etc., as well as a plurality of curves and straight lines to give it a unique shape. The base has at least one edge 14 which has a sidewall 15 extending upwardly therefrom. The sidewall 15 extends around the edge 14 of the base and forms a container or receptacle having an open end 16. The sidewall is preferably of a uniform height around the planter. The portion of the sidewall opposite the edge 14 is an end 17. The end 17 may be with a slight ledge as seen in FIG. 6.

The device of the present invention can have a sidewall that is generally circular or can be a variety of shapes including but not limited to rectangular, square, combinations of curves and straight lines, etc., depending on the shape of the base. In a preferred embodiment the sidewall 15 has a length 18 and a height 19. The length of each sidewall is preferably generally the same length as the length of each edge 14 of the base. Preferably, the angle 20 between the base 11 and the sidewall 15 is about 90 degrees. In one embodiment the angle 20 is greater than 90 degrees. It is desired that the angle not be too great as the greater the angle, there is a risk that the bulbs may have some difficulty in sending roots through openings in the base.

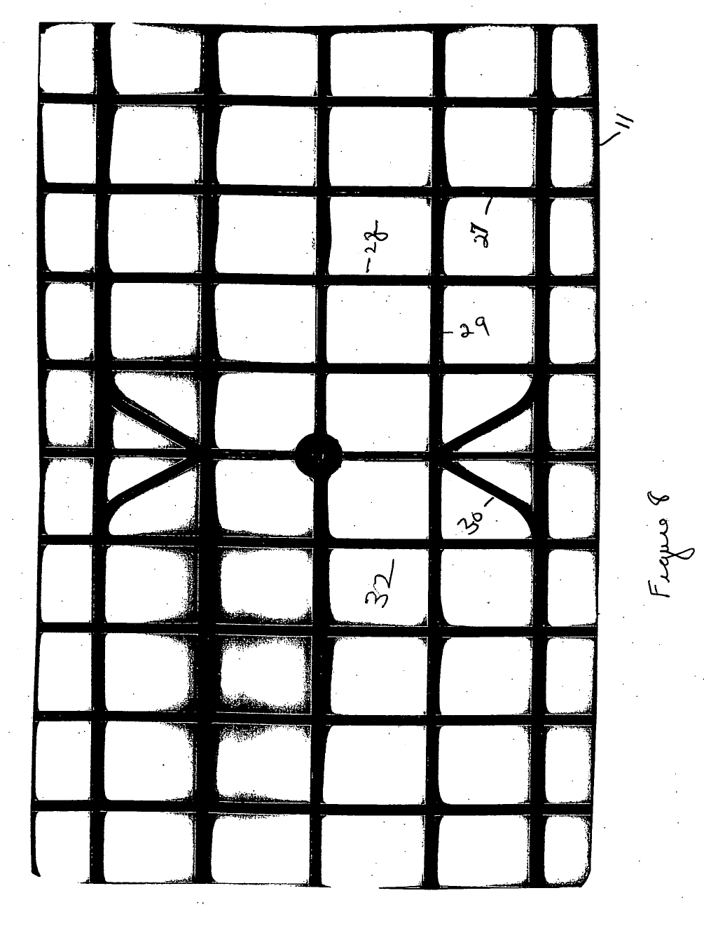

The prior art containers typically have a single orifice for drainage purpose in the base of the container. The number of orifices is such that in a preferred embodiment at least 25% of the area of the base is open. In a more preferred embodiment at least 50% of the base is open area. In a most preferred embodiment the orifices constitute at least 75% of the base forming an open area for roots to pass through. The orifices in the base preferably have the side view construction shown in FIG. 7. The orifice has an orifice side wall 22. The sidewall extends from the inner surface 23 of the base to the outer surface 24 of the base. Preferably the orifice sidewall 22 forms an angle 25 with the outer surface of 90 degrees or less. In a preferred embodiment, the angles 25 are preferably less than 45 degrees. In a more preferred embodiment, the angle 25 is less than 30 degrees. An acute angle at the junction of the orifice side wall and the outer surface of the base provides a slight edge to the orifice sidewall that facilitates removal of the device after the bulbs have bloomed and the bed is being removed. The slight edge causes the roots that have passed from the device to be severed as the apparatus is turned or twisted while on the ground. Although the orifice sidewall 22 is shown forming an acute angle 25, in another embodiment the angle 25 is obtuse and the acute angle is the angle formed by the sidewall 22 and inner surface 23. FIG. 8 shows a preferred base 11 of the present invention. There are a plurality of strips 27. In one embodiment, shown in FIG. 8, there are longitudinal strips 28 and transverse strips 29. There may be one or more additional support strips 30 if desired. The strips form a grid extending from one sidewall to the other sidewall. The openings 32 form an area for the roots of a bulb or other plant to pass from the container into the ground. The strip edges may have a configuration similar to that disclosed in FIG. 7. Alternatively, the configuration could be narrower at the top and bottom and wider in the center similar to FIG. 9. This configuration provides a relatively sharper edge like the arrangement in FIG. 7 to facilitate cutting of the roots as the container is turned or rotated. Typically, the turning of the container at least 90 degrees causes the edges of the strips or sidewall of the orifice to cut the roots. More preferably the container is turned 180 to 360 degrees or more to cut the roots extending through the openings. The strips have a top surface, a bottom surface and at least two side surfaces extending on opposite sides of said strip from said top surface to said bottom surface. Each of said side surfaces form a cutting edge as shown in FIG. 7. Alternatively, there can be two side surfaces on each side of said strip as shown in FIG. 9. These side surface pairs preferably form an angle less than 90 degrees and more preferably an angle less than 60 degrees and most preferably an angle less than 30 degrees.

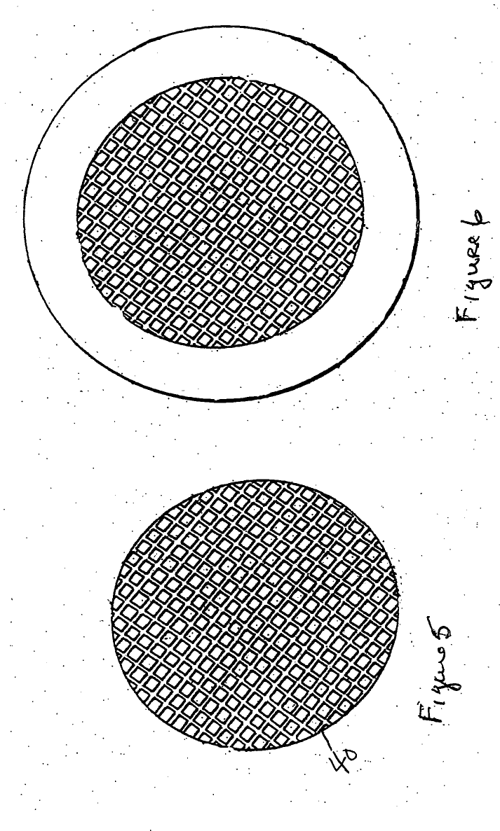

FIG. 5 shows the top surface of the device of the present invention with a porous mesh 40 over the surface. The porous mesh 40 permits air and water to enter the device but prevents vermin from having access to the plants. Preferably, the mesh is made of a material that tears as the plants grow through the mesh so the plant can increase in size easily.

The device of the present invention provides a ready to plant bed of spring bulbs that can be placed directly on the ground without digging a hole in the ground for planting. The apparatus of the present invention can have one or more bulbs placed therein along with a suitable amount of soil, planting mix or pottery mix to secure the bulb or bulbs in place. As noted above, the height of the sidewalls is preferably about 3-8 or so inches high to accommodate the preferred planting depths of the various bulbs. In order to plant the device the device is placed directly onto the surface where the bulbs are to bloom. Preferably, the area is open dirt without grass or thatch present. However, none of the soil underneath the device needs to be dug prior to placement. This renders the device easy to plant in a minimum amount of time. The device when placed directly on the ground can have one or more other devices placed next to the side walls to make a large scale bed of spring bulbs. Alternatively, if only one device is planted, soil, mulch or potting mix can be placed up against the outside side walls to hide the sidewall if desired. In a preferred embodiment, the area where the device will be planted may be a raised bedding area that has a retaining wall that extends above the surface of the soil. This permits the device to be positioned on the soil so that it does not rise above the adjacent plantings.

Once the bulbs have finished blooming the device of the present invention may be removed from the garden. The bulbs may be readily disposed of or if the gardener wishes to grow the bulbs the following year the device may be removed and moved to an unobtrusive location where the foliage can replenish the nutrients need for the bulbs next growing cycle. Thus, the location where the bulbs had been previously planted can be used for other plantings. In order to remove the device, the sidewalls can be grasped after the soil around them has been removed. Once the soil has been removed, the device is given a twisting or circular motion when the edges of the orifice sidewalls slice any roots that have passed through the orifices thus permitting removal of the device. If desired, the sidewalls may also be provided with one or more orifices to permit side growing roots to pass through the sidewalls.

The advantage of the present invention is that bulbs that traditionally had to be planted in the soil to protect them from the frost of winter can now be planted on the ground surface through the use of the device of the present invention. This permits the gardener to avoid the heavy labor of building a bed in the soil. The bulbs in the device of the present invention can be planted in the fall or the spring if desired as there is no need to have the bulbs placed directly into the ground. The device of the present invention also permits the gardener to place a plurality of the devices together to mass the bulbs in a large display in the bed without a great deal of effort. Also, the device permits the beds to be cleaned easily when the blooming season is completed.

1. A container for planting a plant, said container comprising a base and at least one sidewall, said sidewall forming an open area for receiving one or more plants and a soil mixture, said base having a plurality of openings therein for roots of said plant to pass through said base into the soil on which the container is placed.

2. The container according to claim 1 wherein said container is for planting bulbs.

3. The container according to claim 1 wherein said openings have a sidewall around the perimeter of said opening, said opening sidewall forming an acute angle with at least one of an inner surface of said base or an outer surface of said base.

4. The container according to claim 3 wherein said openings comprise at least 75% of the area of said base.

5. The container according to claim 1 wherein said base has a first plurality of strips extending from a first sidewall to the opposite second sidewall and a second plurality of strips extending from a third sidewall to an opposite fourth sidewall, said strips forming a plurality of openings in said base.

6. The container according to claim 5 wherein said strips have a top surface and a bottom surface and at least one side surface and wherein said side surface forms an edge with another surface of said strip to provide a cutting surface for cutting roots from a plant passing through said opening when said container is turned at least 90 degrees.

7. The container according to claim 6 wherein said strip has a top surface, a bottom surface and at least two side surfaces, said side surfaces forming an edge where they meet at an angle of less than 90 degrees.

8. A flower bed formed of a plurality of the containers according to claim 1.

9. A method of planting a flower garden comprising placing on the top surface of the soil a container, said container comprising a base and at least one sidewall, said sidewall forming an open area for receiving one or more plants and a soil mixture, said base having a plurality of openings therein for roots of said plant to pass through said base into the soil on which the container is placed; placing a substrate against the outer surface of the sidewall of said container for holding the container in place; permitting said plant to grow so that the roots of said plant extend from said container through the orifices in said base, twisting said container after said plant has grown to sever any roots extending through said orifices.
